(19) United States
(12) Patent Application Publication
(10) Pub. No.: US 2026/0197924 A1
(43) Pub. Date: Jul. 9, 2026

(54) STREETLIGHTS WITH DIRECTIONAL ANTENNA MODULES

(71) Applicant: SIGNIFY HOLDING B.V., EINDHOVEN (NL)

(72) Inventors: TIES VAN BOMMEL, HORST (NL); GUIDO THEO MARIA LAMERICHS, HOESELT (BE); ROBERT JACOB PET, WAALRE (NL)

(21) Appl. No.: 19/132,410

(22) PCT Filed: Nov. 27, 2023
(86) PCT No.: PCT/EP2023/083163

§ 371 Date: May 23, 2025

(30) Foreign Application Priority Data
Dec. 2, 2022 (EP) 22210984.5

(51) Int. Cl. H05B 47/19; F21S 8/08; F21Y 115/10; H01Q 1/22

(52) U.S. Cl. CPC H05B 47/19; F21S 8/086; H01Q 1/22; F21Y 2115/10

(57) ABSTRACT

A streetlighting system (100) comprising a plurality of streetlights for establishing line-of-sight communication links between any two adjacent streetlights. The streetlighting system (100) comprises a second streetlight (300) comprising a second luminaire (310) mounted on a second pole (330) and configured to provide a second horizontally elongated light distribution (311); a second antenna unit (320) comprising a third antenna module (350) and a fourth antenna module (360), wherein the third antenna module (350) is configured to emit a third directional radio beam (321) and the fourth antenna module (360) is configured to emit a fourth directional radio beam (322); wherein beam axes (323, 324) of the third and the fourth directional radio beams (321, 322) are oriented to different directions with a second mutual angle (θ₂) when projected on the horizontal plane (HP), and wherein 1OO°≤θ₂≤17O° or 19O°≤θ₂≤26O°; and the third and the fourth directional radio beams (321, 322) are arranged along a respective portion (P3, P4) of the second horizontally elongated light distribution (311).

### FIELD OF THE INVENTION

The invention relates to a streetlighting system for both illumination and communication. The streetlighting system comprises a plurality of said outdoor streetlights, wherein the streetlights comprise directional antenna modules for pole-to-pole wireless communication.

### BACKGROUND OF THE INVENTION

Outdoor lighting systems have been designed and deployed to provide illumination to improve visibility in the absence of natural daylight throughout the outdoor environment, such as on streets, in parks, at airports, and other public and/or private outdoor venues. However, there are several shortcomings with traditional street lighting on roads, such as glare, non-uniform light pattern, upward reflected light, light pollution, and waste of energy. Furthermore, old lighting technologies may also limit both eye comfort and visual perception of car drivers and pedestrians. To overcome these shortcomings streetlights with customized spatial light distributions may be used. For example, a recent trend is the use of light emitting diode systems as light sources in such streetlights. A cobra head design is adopted to ensure that light emitted by a streetlight is emitted downwards, i.e., towards the ground, thereby reducing light pollution.

In the meanwhile, there is a growing need for network connectivity, in particular in the smart city context. By deploying audio, video and environmental sensors municipalities want to better monitor and interact with the outdoor environment, this in combination with data collection and artificial intelligence allows for a better understanding and control of the urban environment.

Furthermore, there is a surging need for network densification not only in the cities but also around the cities. The outdoor lighting infrastructure turns to be a ready-built foundation for city-wide connectivity, and the streetlights also function as nodes in a communication network. However, connecting communication modules to smart poles has so far been possible but time-consuming and labor-intensive, e.g., requiring labor-intensive on-site installation.

US2018123692A1 relates to systems and methods for communicating through a glass window barrier, in which one communication device, placed outdoors near the glass window, utilizes optical signals to propagate communication signals through the glass window, and communicate with another communication device placed indoors near the same glass window.

### SUMMARY OF THE INVENTION

Society has been penetrated by digitization, and reliable data communication is required almost everywhere, in urban areas as well as in rural areas. For example, major cities do not necessarily offer better Internet access than less populated areas. As user numbers increase, so does the use of the available spectrum, and if networks cannot cope with the increasing demands, this can result in bottlenecks, congestion, and slow connection speeds. Therefore, there is a high demand to provide a city wide backbone network for faster data connectivity in a ubiquitous way, and to extend the backbone network towards rural areas. High-speed wireless backbone networks are seen as a promising alternative and a cheaper way to backhaul data than fiber-based solutions.

Given the intensive utilization in radio frequency band, millimeter-wave frequency band located in the range of 30 to 300 GHz turns to be a nice candidate for building up the high-speed wireless backbone networks given its huge available bandwidth. However, millimeter-wave frequency band also has its downsides. For example, it has fast attenuation at distance and it is likely to be absorbed by the atmosphere too. Therefore, millimeter-wave communications are typically propagated line of sight (LOS) for better transmission and reception, which results in the emergence of mesh based LOS networks. The major challenge for deployment comes with the number of nodes in such LOS networks, which will require support from civil infrastructure like lampposts.

On the other hand, although outdoor lighting systems are good candidates for providing communication services beyond lighting, the uptake of connected lighting services does not appear to be in line with the need for such services. For example, to deploy a wireless data communication network will require mounting of additional wireless radio communication devices to the lighting fixtures, which may result in rather unsightly pods or modules. Furthermore, directional radio communication links are typically necessary to reduce power consumption and to support a high-speed data link. However, mounting and installation of such directional antennas on a streetlight can be labor-intensive and lead to a high cost.

In view of the above, the present disclosure is directed to a system for providing a simple and efficient solution to integrate antenna modules for communication into streetlights. More particularly, the goal of this invention is achieved by a streetlighting system as claimed in claim 1.

In accordance with a first aspect of the invention a streetlighting system is provided. A streetlighting system comprising a plurality of streetlights for establishing line-of-sight communication links between any two adjacent streetlights out of the plurality of streetlights in the streetlighting system; wherein the streetlighting system comprises:
a first streetlight out of the plurality of streetlights comprising:
   a first luminaire mounted on a first pole and configured to provide a first horizontally elongated light distribution;
   a first antenna unit comprising a first antenna module and a second antenna module wherein the first antenna module is configured to emit a first directional radio beam and the second antenna module is configured to emit a second directional radio beam; wherein beam axes of the first and second directional radio beams are oriented to different directions with a first mutual angle (θ₁) of essentially 180 degrees when projected on a horizontal plane (HP); and the first and the second directional radio beams are arranged along a respective portion of the first horizontally elongated light distribution, such that directional radiation patterns of the first antenna unit are correlated to the first horizontally elongated light distribution of the first streetlight; and
a second streetlight out of the plurality of streetlights comprising:
   a second luminaire mounted on a second pole and configured to provide a second horizontally elongated light distribution;
   a second antenna unit comprising a third antenna module and a fourth antenna module, wherein the third antenna module is configured to emit a third directional radio beam and the fourth antenna module is configured to emit a fourth directional radio beam; wherein beam axes of the third and the fourth directional radio beams are oriented to different directions with a second mutual angle (θ₂) when projected on the horizontal plane (HP), and wherein 100°≤θ₂≤170° or 190°≤θ₂≤260°; and the third and the fourth directional radio beams are arranged along a respective portion of the second horizontally elongated light distribution, such that directional radiation patterns of the second antenna unit are correlated to the second horizontally elongated light distribution of the second streetlight; and wherein the first horizontally elongated light distribution is different from the second horizontally elongated light distribution.

Note that the first horizontally elongated light distribution may differ from the second horizontally elongated light distribution in terms of one or more of the following:
length of the spatial light distribution, preferably the first horizontally elongated light distribution may have a longer length than the second;
width of the spatial light distribution, preferably the first horizontally elongated light distribution may have a smaller width than the second;
shape of the spatial light distribution, preferably the first horizontally elongated light distribution is straight, while the second is curved;
pattern of the spatial light distribution, preferably the first horizontally elongated light distribution has a continuous illumination area, while the second horizontally elongated light distribution has multiple illumination areas, i.e., patterned light distribution.

The minimum difference between θ₁ and θ₂ may be 10 degrees.

As aforementioned, it is desirable to transform or upgrade existing outdoor luminaires into a connectivity grid to provide network densification in and around cities. The plurality of streetlights comprised in the streetlighting system are used to establish line-of-sight (LOS) communication links between any two adjacent streetlights in the system, such that each streetlight acting as a node in the LOS networks and high-speed data is propagated from pole to pole. To simplify the incorporation of such wireless backbone network in a streetlighting system, it is beneficial to correlate the spatial light distribution of a streetlight with directional radiation patterns of the antennas in said streetlight.

In the streetlighting system, light distributions of the first streetlight and the second streetlight are designed individually to cater for different deployment scenarios, thereby reducing under-illuminated dark areas without causing light pollution. This also helps to reduce energy waste in a traditional streetlighting system. By correlating antenna radiation patterns with the spatial light distributions, the benefits to a lighting system are also inherited by a LOS communication grid integrated in the streetlighting system. Therefore, the radio beams of one node in the LOS communication grid are directed to adjacent nodes in an efficient manner.

For a directional antenna, the antenna is designed to radiate most of its power in the lobe directed in one desired direction. Therefore, in the radiation plot this lobe appears larger than the others, which is called the main lobe. The axis of maximum radiation, passing through the center of the main lobe, is called the “beam axis” or “boresight axis”. Here, for simplicity, a directional radio beam represents the main lobe of an actual radiated radio beam by a certain directional antenna module.

The directional radio beams are of narrow beam angle. Beam angle or beam width is the aperture angle from where most of the power is radiated. For example, the half power beam width is the angle between the half-power (−3 dB) points of the main lobe of the radiation pattern. For the horizontal plane, beam angle or beam width is usually expressed in degrees. The beam angle of the directional radio beams radiated by the first or the second antenna module are typically smaller than 30 degrees, preferably smaller than 10 degrees. The narrower the beam, the better the power efficiency of the communication links.

The first and the second directional radio beams are arranged along a respective portion of the first horizontally elongated light distribution such that the beam axes are covered by or in parallel to the respective portion of the first horizontally elongated light distribution when projected on the horizontal plane (HP). Similarly, the third and the fourth directional radio beams are arranged along a respective portion of the second horizontally elongated light distribution such that the beam axes are covered by or in parallel to the respective portion of the second horizontally elongated light distribution when projected on the horizontal plane (HP).

Such directional radio beams may comprise side lobes, the directivity is mainly determined by the main lobes. Depending on the actual deployment scenario, the plurality of streetlights may be according to either the first streetlight or the second streetlight, or a combination of the two types. For example, the first streetlight is suitable for being deployed at a straight part of the road provides a straight elongated spatial light distribution and the corresponding two directional radio beams are arranged in similar directions, i.e., east and west and/or north and south. The second streetlight is suitable for being deployed at a bend of the road providing a curved elongated spatial light distribution and the corresponding two directional radio beams are arranged in similar directions, i.e., bended with respect to each other.

The beam axes of the first and second directional radio beams are oriented to different directions with the first mutual angle (θ₁) of essentially 180 degrees when projected on the horizontal plane. Here, essentially 180 degrees indicates θ₁ may have +/−3 degrees variation around 180 degrees.

The first antenna module and the second antenna module may be placed on the same PCB or in the same housing. It may also be possible that the first antenna module and the second antenna module are packaged separately. Similarly, the third antenna module and the fourth antenna module may be placed on the same PCB or in the same housing. It may also be possible that the third antenna module and the fourth antenna module are packaged separately.

Beneficially, the first elongated light distribution has a first main optical axis, and the beam axis of at least one of the first directional radio beam and the second directional radio beam are perpendicular to the first main optical axis; and the second elongated light distribution has a second main optical axis, and the beam axis of at least one of the third directional radio beam and the fourth directional radio beam is perpendicular to the second main optical axis.

In one setup, the first and/or the second main optical axis is a vertical axis along the direction of gravity. Correspondingly, the first and second directional radio beams and/or the third and fourth directional radio beams are located in a horizontal plane perpendicular to the direction of gravity.

In that sense, the directivity of the light beams is towards the ground and in the direction of gravity, while the directivity of the radio beams is horizontal and towards the adjacent streetlights.

Preferably, the first antenna module is comprised in the first luminaire, and the second antenna module is comprised in the second luminaire.

To reduce cost and effort on manual installation of antenna modules, it may be quite beneficial to integrate antenna modules directly in the luminaires. Considering that the light distribution of the streetlights is typically arranged to follow the street or road layout, with the correlated light distribution and radiation of radio beams according to the present invention, it may facilitate the deployment of high-speed LOS backbone networks with pre-manufactured streetlights.

Advantageously, the first luminaire comprises a first light source and a first optical element for providing the first horizontally elongated light distribution; and the second luminaire comprises a second light source and a second optical element for providing the second horizontally elongated light distribution, wherein a first combination of the first light source and the first optical element is different from a second combination of the second light source and the second optical element.

The first and or second optical element may comprise a lens, a lens array, a diffuser, or an optical filter.

Preferably, the first light source and the second light source are both light-emitting diode, LED, based light sources, and the first optical element is different from the second optical element.

The difference between the first optical element and the second optical element may be in terms of one or more out of
a shape,
a curvature,
material,
a refractive index, and
a color.

In another example, the first light source comprises a first matrix of first LEDs and the second LED light source comprises a second matrix of second LEDs, wherein the first matrix is different from the second matrix.

The difference between the first matrix and the second matrix may be in terms of one or more out of
different types of a first LED and a second LED;
the number of LEDs;
the pitch sand/or arrangement of LEDs;
the intensity of the LEDs; and
the color point and/or color temperature of the LEDs.

In a further example, the first and/or the second optical element comprises one or more peanut lenses.

Advantageously, the first antenna unit is directly physically mounted to the first optical element to couple directions of the first and the second directional radio beams and the first horizontally elongated light distribution; and the second antenna unit is directly physically mounted to the second optical element to couple directions of the third and the fourth directional radio beams and the second horizontally elongated light distribution, preferably to couple the directions of the radio beams to the respective portions of the first and second horizontally elongated light distributions.

In a further example, the second luminaire has a second longitudinal axis, and the third and the fourth directional radio beams are asymmetrically oriented with respect to the second longitudinal axis.

Similarly, the first luminaire has a first longitudinal axis, while the first and the second directional radio beams are symmetrically oriented with respect to the first longitudinal axis.

The first and second longitudinal axes pass through the centroid, or geometric center of the respective luminaire. After installing a luminaire, a longitudinal axis is essentially perpendicular to the elongation of a road or street.

Beneficially, the first antenna module and the second antenna module are configured to operate in a frequency band within a range of 30 GHz to 300 GHz.

Millimeter Wave spectrum is much in demand for providing gigabits per second. Millimeter waves are being used to provide high data rates using advanced technologies like massive MIMO etc. Apart from the required benefits from millimeter wave, there are some drawbacks too. It has fast attenuation at distance and it is likely to be absorbed by the atmosphere too.

Within the millimeter Wave spectrum, it is preferable to operate the antenna modules at 60 GHz frequency band, given the commercial availability of 60 GHz radios. It is also known that 60 GHz radio waves are typically propagated line of sight (LOS) for better transmission and reception. Thanks to the high data rate advantage of 60 GHz spectrum band, the streetlights may be used to function as LOS access points in a mesh connectivity to create the backbone data network.

In one setup, the first antenna unit is configured to assist a first bi-directional communication link between antenna modules mounted on two adjacent streetlights on either side of the first streetlight; and the second antenna unit is configured to assist a second bi-directional communication link between antenna modules mounted on two adjacent streetlights on either side of the second streetlight.

In one option, the first streetlight is next to the second streetlight, such that the second antenna module faces and communicates with the third antenna module.

Note that the second antenna module does not face or communicate with the fourth antenna module.

In a further example, a directivity of the first, second, third, or fourth antenna module is further determined by a relative mounting height between the first, second, third, or fourth antenna module and a corresponding antenna module mounted on a corresponding adjacent streetlight for establishing a line-of-sight communication link with the first, second, third, or fourth antenna module, respectively.

It may also be possible that the street or road has a certain slope. And then the directivity of the first antenna module or the second antenna module may be determined by both the orientation of the adjacent streetlights and the relative mounting height of the corresponding antenna modules in the adjacent streetlights.

Beneficially, a deployment of a further streetlight in the streetlighting system according to a type of the first streetlight or the second streetlight is determined by a curvature of a road that the streetlighting system is to be deployed.

In a further example, the streetlighting system comprises a third streetlight comprising:
a third luminaire mounted on a third pole and configured to provide a third horizontally elongated light distribution;
a third antenna unit comprising a fifth antenna module and a sixth antenna module, wherein the fifth antenna module is configured to emit a fifth directional radio beam and the sixth antenna module is configured to emit a sixth directional radio beam; wherein beam axes of the fifth and the sixth directional radio beams are oriented to different directions with a third mutual angle (θ₃) when projected on the horizontal plane (HP), and wherein 100°≤θ₃≤170° or 190°≤θ₃≤260°; and the fifth and the sixth directional radio beams are arranged along a respective portion of the third horizontally elongated light distribution.

Note that the fifth and the sixth directional radio beams are arranged along the respective portion of the third horizontally elongated light distribution such that the beam axes are covered by or in parallel to the respective portion of the third horizontally elongated light distribution when projected on the horizontal plane (HP).

In one example, θ₁≠θ₂≠θ₃.

A minimum difference among θ₁, θ₂, θ₃ may be 10 degrees.

In one example, the fifth antenna module faces and communicates with the fourth antenna module. In another example, the sixth antenna module faces and communicates with the first antenna module.

In a further example, the streetlighting system comprises a fourth streetlight comprising:
a fourth luminaire mounted on a fourth pole configured to provide a fourth light distribution with two horizontally elongated light distributions intersected at the center;
a fourth antenna unit comprising four antenna modules with each configured to emit a directional radio beam; wherein beam axes of the four directional radio beams are oriented to different directions with any two adjacent directional radio beams having a mutual angle (θ₄) of essentially 90 degrees when projected on the horizontal plane (HP); and the four directional radio beams are arranged along a respective portion of the fourth light distribution.

Note that the four directional radio beams are arranged along the respective portion of the fourth light distribution such that the beam axes are covered by or in parallel to the respective portion of the fourth light distribution when projected on the horizontal plane (HP).

Preferably, the fourth streetlight is deployed at a crossing of a road.

In order to handle different road/street layouts in a flexible and efficient manner, the streetlighting system may comprise different types of streetlights according to the present invention. By knowing the layout of the roads/streets where the streetlighting system is to be deployed, the selection and customization of streetlights can be planned beforehand. For example, the plurality of streetlights can be prefabricated according to the actual layout of the road/street, and the installation location of each streetlight can be pre-determined, which can reduce the workload of on-site installation significantly.

Beneficially, the second horizontally elongated light distribution has a curved shape when projected in the horizontal plane and/or the respective portions (P3, P4) of the second horizontally elongated light distribution are along the beam axis of the third and fourth directional radio beams.

Beneficially, the first, second and optionally third horizontally elongated light distribution are aligned with respect to the elongation of a road or street.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 illustrates an example of a streetlighting system top view;

FIG. 2 illustrates an example of a streetlight side view;

FIG. 3 illustrates an example of a second streetlight top view;

FIG. 4 shows one deployment of a streetlighting system top view;

FIG. 5 shows a further deployment of a streetlighting system top view;

FIG. 6 shows different options of the second horizontally elongated light distribution top view; and

FIG. 7 shows an example of a fourth streetlight top view.

### DETAILED DESCRIPTION OF EMBODIMENTS

The embodiments set forth below represent information to enable those skilled in the art to practice the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

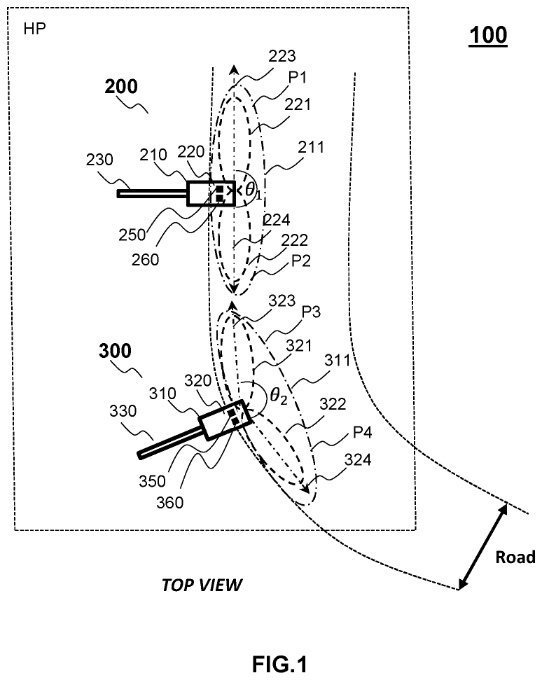

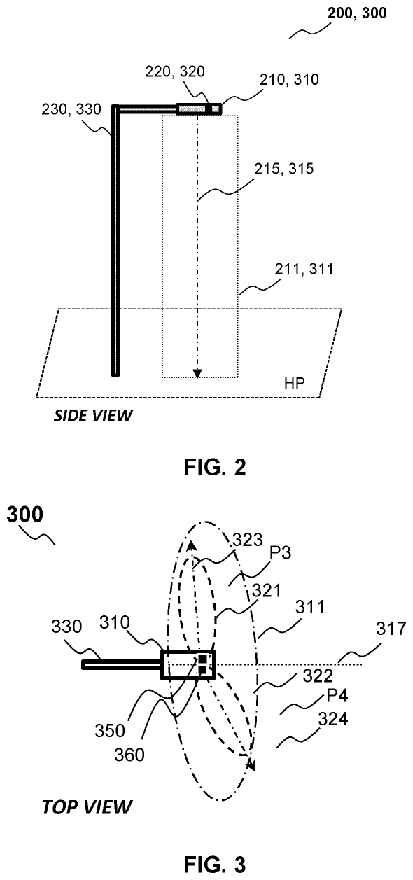

FIG. 1 exemplarily illustrates a top view of a streetlighting system 100 according to the present invention, and FIG. 2 exemplarily illustrates a side view of the first streetlight 200 and the second streetlight 300. The streetlighting system 100 comprises a plurality of streetlights for establishing line-of-sight communication links between any two adjacent streetlights out of the plurality of streetlights in the streetlighting system 100. The streetlighting system 100 comprises:
a first streetlight 200 out of the plurality of streetlights comprising:
   a first luminaire 210 mounted on a first pole 230 and configured to provide a first horizontally elongated light distribution 211;
   a first antenna unit 220 comprising a first antenna module 250 and a second antenna module 260 wherein the first antenna module 250 is configured to emit a first directional radio beam 221 and the second antenna module 260 is configured to emit a second directional radio beam 222; wherein beam axes 223, 224 of the first and second directional radio beams 221, 222 are oriented to different directions with a first mutual angle (θ₁) of essentially 180 degrees when projected on a horizontal plane (HP); and the first and the second directional radio beams 221, 222 are arranged along a respective portion (P1, P2) of the first horizontally elongated light distribution 211; and
a second streetlight 300 out of the plurality of streetlights comprising:
   a second luminaire 310 mounted on a second pole 330 and configured to provide a second horizontally elongated light distribution 311;
   a second antenna unit 320 comprising a third antenna module 350 and a fourth antenna module 360, wherein the third antenna module 350 is configured to emit a third directional radio beam 321 and the fourth antenna module 360 is configured to emit a fourth directional radio beam 322; wherein beam axes 323, 324 of the third and the fourth directional radio beams 321, 322 are oriented to different directions with a second mutual angle (θ₂) when projected on the horizontal plane (HP), and wherein 100°≤θ₂≤170° or 190°≤θ₂≤260°; and the third and the fourth directional radio beams 321, 322 are arranged along a respective portion (P3, P4) of the second horizontally elongated light distribution 311, and
wherein the first horizontally elongated light distribution 211 is different from the second horizontally elongated light distribution 311.

Note that the first horizontally elongated light distribution 211 differs from the second horizontally elongated light distribution 311 in terms of one or more of the following:
length of the spatial light distribution, preferably the first horizontally elongated light distribution may have a longer length than the second;
width of the spatial light distribution, preferably the first horizontally elongated light distribution may have a smaller width than the second;
shape of the spatial light distribution, preferably the first horizontally elongated light distribution is straight, while the second is curved;
pattern of the spatial light distribution, preferably the first horizontally elongated light distribution has a continuous illumination area, while the second horizontally elongated light distribution has multiple illumination areas, i.e., patterned light distribution.

The minimum difference between θ₁ and θ₂ may be 10 degrees.

The need to provide fast data connectivity in a ubiquitous manner to facilitate the transition to a digital society has led to a trend of deploying high-speed backbone networks in and around cities. As compared to a fiber-based solution, a wireless backbone network turns out to be a promising alternative and a cheaper way to backhaul data.

Given the data rate requirements of Gbps or higher, mm Wave frequency bands in the 30 to 300 GHz range are ideal for building high-speed wireless backbone networks with their vast available bandwidth. Preferably, the wireless backbone network may operate in the 60 GHz frequency band, which spans approximately 51-71 GHz. However, as compared to the radio frequency band, the millimeter wave frequency band also has the disadvantages of fast attenuation with distance and high atmospheric absorption rate. Therefore, millimeter wave communications typically employ line-of-sight (LOS) propagation for better transmission and reception. It is convenient and cost-effective to use or upgrade existing civil infrastructure, such as lampposts, to deploy such wireless backbone networks.

It's proposed in this invention that the plurality of streetlights in the streetlighting system are used to establish the LOS communication links between any two adjacent streetlights, such that each streetlight acts as anode in the LOS networks and high-speed data is propagated from pole to pole. To simplify the integration of such wireless backbone network in a streetlighting system, it is proposed to correlate the spatial light distribution of a streetlight with directional radiation patterns of the antennas in said streetlight.

The first and the second directional radio beams 221, 222 are arranged along the respective portion (P1, P2) of the first horizontally elongated light distribution 211 such that the beam axes 223, 224 are covered by or in parallel to the respective portion P1, P2 of the first horizontally elongated light distribution 211 when projected on the horizontal plane (HP).

The third and the fourth directional radio beams 321, 322 are arranged along a respective portion (P3, P4) of the second horizontally elongated light distribution 311 such that the beam axes 323, 324 are covered by or in parallel to the respective portion (P3, P4) of the second horizontally elongated light distribution 311 when projected on the horizontal plane (HP).

The elongated light distributions of the first streetlight and the second streetlight are customized individually to cater for different deployment scenarios, thereby reducing under-illuminated dark areas without causing light pollution. For example, the first streetlight may be deployed in a straight part of the road, while the second streetlight may be deployed in a curved part of the road. By knowing the layout of the road/street and the distance between adjacent streetlights, the elongated light distributions of the first and the second streetlights can be optimized. This also helps to reduce energy waste in a traditional streetlighting system. By correlating antenna radiation patterns with the spatial light distributions, the benefits to a lighting system are also inherited by a LOS communication grid embedded in the streetlighting system. Therefore, the radio beams of each node in the LOS communication grid are directed to adjacent nodes in an efficient manner.

In the LOS communication grid, the first antenna module 220 is configured to assist a first bi-directional line-of-sight communication link between antenna modules mounted on two adjacent streetlights next to the first streetlight 200; and the second antenna module 320 is configured to assist a second bi-directional communication link between antenna modules mounted on two adjacent streetlights next to the second streetlight 300. A plurality of streetlights according to either the first streetlight or the second streetlight is deployed to establish a LOS backbone network.

The antenna units 220, 320 of the first and the second streetlights 200, 300 may be mounted directly on the pole, or integrated in the luminaires 210, 310 of the first and the second streetlights 200, 300.

Depending on the antenna module's mounting position in a streetlight, it may be possible that when projected on the horizontal plane, the directional radio beams emitted by the antenna module are partially or completely covered by the elongated light distribution. Alternatively, the beam axes of the directional radio beams may be along the extension of the road and parallel to the elongated light distribution.

The directivity of the antenna modules 250, 260, 350, 360 may be further determined by a relative mounting height between an individual antenna module 250, 260, 350, 360 and a corresponding antenna module mounted on a corresponding adjacent streetlight for establishing a line-of-sight communication link between the individual antenna module 250, 260, 350, 360 and the corresponding antenna module mounted on a corresponding adjacent streetlight.

In one example, the first luminaire 210 comprises a first light source and a first optical element for providing the first horizontally elongated light distribution 211; and the second luminaire 310 comprises a second light source and a second optical element for providing the second horizontally elongated light distribution 311, wherein a first combination of the first light source and the first optical element is different from a second combination of the second light source and the second optical element.

The optical element may be a lens, a lens array, a diffuser, or an optical filter.

The first light source and the second light source may be both light-emitting diode, LED, based light sources, and the first optical element is different from the second optical element.

As an example, the different spatial light distributions of the first and second streetlights may be created by the LED light source in combination with different optical elements each providing a different spatial light distribution.

In one option, the first optical element is different from the second optical element.

The difference between the first optical element and the second optical element may be in terms of one or more out of a shape, a curvature, material, a refractive index, and a color.

In another example, the first light source comprises a first matrix of first LEDs and the second LED light source comprises a second matrix of second LEDs, wherein the first matrix is different from the second matrix.

The difference between the first matrix and the second matrix may be in terms of one or more out of: different types of a first LED and a second LED; the number of LEDs; the pitch sand/or arrangement of LEDs; the intensity of the LEDs; and the color point and/or color temperature of the LEDs.

Preferably, the first and/or the second optical element may comprise one or more peanut lenses.

In one example, the first antenna unit 220 is directly physically mounted to the first optical element to couple directions of the first and the second directional radio beams 221, 222 and the first horizontally elongated light distribution 211; and the second antenna unit 320 is directly physically mounted to the second optical element to couple directions of the third and the fourth directional radio beams 321, 322 and the second horizontally elongated light distribution 311.

FIG. 2 exemplarily illustrates a top view of a streetlight 200, 300 according to one example. In the side view, the first elongated light distribution 211 has a first main optical axis 215, and the second elongated light distribution 311 has a second main optical axis 315.

In one example, the beam axis 223, 224 of at least one of the first directional radio beam 221 and the second directional radio beam 222 is perpendicular to the first main optical axis 215. Similarly, a beam axis 323, 324 of at least one of the third directional radio beam 321 and the fourth directional radio beam 322 is perpendicular to the second main optical axis 315.

In a further example, the first and/or the second main optical axis 215, 315 is a vertical axis along the direction of gravity. Correspondingly, the first and second directional radio beams 221, 222 and/or the third and fourth directional radio beams 321, 322 are located in a horizontal plane perpendicular to the direction of gravity.

FIG. 3 illustrates an example of a second streetlight top view according to one implementation. In this example, the second luminaire 310 has a second longitudinal axis 317, and the beam axes 323, 324 of the third and the fourth directional radio beams 321, 322 are asymmetrically oriented with respect to the second longitudinal axis 317.

The second longitudinal axis 317 passes through the centroid, or geometric center of the second luminaire 310. After installing the luminaire, the second longitudinal axis 317 may be essentially perpendicular to the elongation of a road or street. This option may be used to fit the second streetlight to some special corners on the road.

Similarly, the first luminaire may have a first longitudinal axis, while the first and the second directional radio beams (211, 222) are symmetrically oriented with respect to the first longitudinal axis.

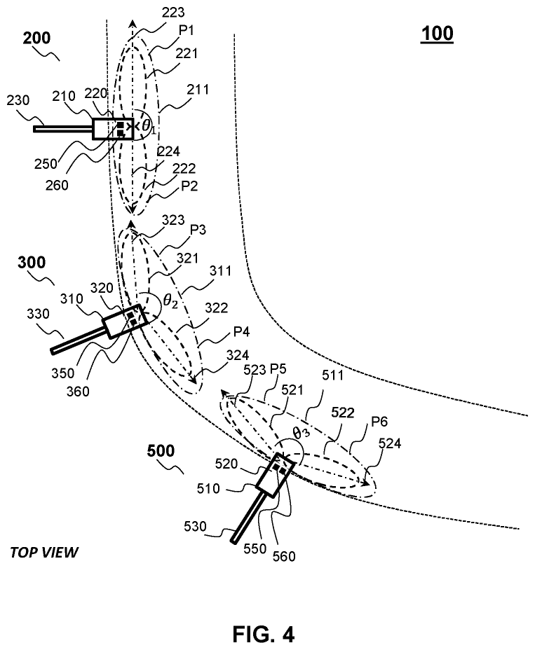

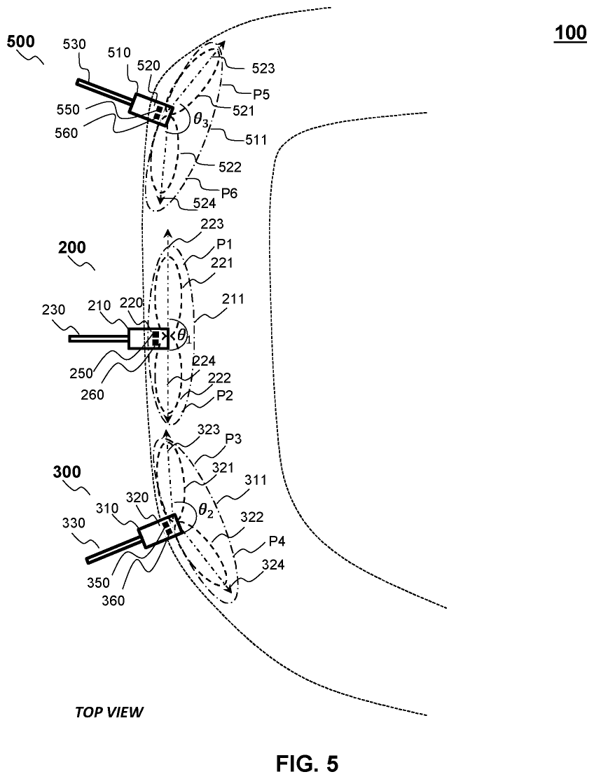

The streetlighting system may further comprise a third streetlight 500 as shown in FIG. 4 and FIG. 5. The third streetlight 500 comprises:
a third luminaire 510 mounted on a third pole 530 and configured to provide a third horizontally elongated light distribution 511;
a third antenna unit 520 comprising a fifth antenna module 550 and a sixth antenna module 560, wherein the fifth antenna module 550 is configured to emit a fifth directional radio beam 521 and the sixth antenna module 560 is configured to emit a sixth directional radio beam 522; wherein beam axes 523, 524 of the fifth and the sixth directional radio beams 521, 522 are oriented to different directions with a third mutual angle (θ₃) when projected on the horizontal plane (HP), and wherein 100°≤θ₃≤170° or 190°≤θ₃≤260°; and the fifth and the sixth directional radio beams 521, 522 are arranged along a respective portion P5, P6 of the third horizontally elongated light distribution 511.

The fifth and the sixth directional radio beams 521, 522 are arranged along the respective portion P5, P6 of the third horizontally elongated light distribution 511 such that the beam axes 523, 524 are covered by or in parallel to the respective portion P5, P6 of the third horizontally elongated light distribution 511 when projected on the horizontal plane (HP)

The third streetlight 500 may be a same type of the second streetlight 300, while θ₂ may be different from θ₃.

According to one setup, θ₁≠θ₂≠θ₃.

The minimum difference among θ₁, θ₂, θ₃ may be 10 degrees.

Similarly, the third luminaire may have a third longitudinal axis, and the fifth and the sixth directional radio beams 521, 522 may be asymmetrically oriented with respect to the third longitudinal axis.

FIG. 4 shows a top view of one deployment of a streetlighting system 100 comprising first, second and third streetlight 200, 300, 500. In this example, the second streetlight 300 is placed between the first streetlight 200 and the third streetlight 500, and the fifth antenna module 550 faces and communicates with the fourth antenna module 360 with a LOS link.

FIG. 5 shows a top view of a further deployment of a streetlighting system 100 comprising first, second and third streetlight 200, 300, 500. In this example, the first streetlight 200 is placed between the third streetlight 500 and the second streetlight 300, and the sixth antenna module 560 faces and communicates with the first antenna module 250 with a LOS link.

In one example, the first longitudinal axis may be non-parallel to the second longitudinal axis and/or the second longitudinal axis may be non-parallel to the third longitudinal axis; and/or the first longitudinal axis may be non-parallel to the third longitudinal axis when projected in the horizontal plane.

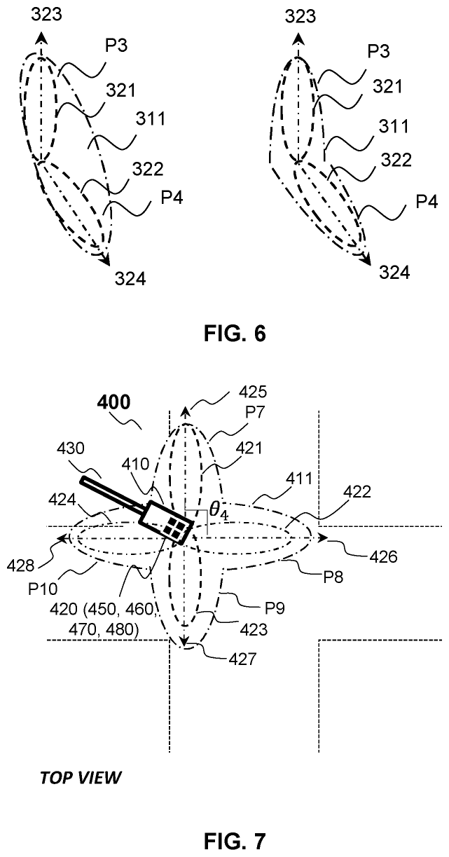

FIG. 6 shows different options of the second horizontally elongated light distribution 311 top view. Depending on the optical component adopted in the second luminaire, the horizontally elongated light distribution 311 may provide different shapes on the top view.

Preferably, the second horizontally elongated light distribution 311 has a curved shape when projected in the horizontal plane and/or (ii) the respective portions (P3, P4) of the second horizontally elongated light distribution 311 are along the beam axes 323, 324 of the third and fourth directional radio beams 321, 322.

FIG. 7 shows a deployment of a fourth streetlight 400 top view. The fourth streetlight 400 comprises:
a fourth luminaire 410 mounted on a fourth pole 430 configured to provide a fourth light distribution 411 with two horizontally elongated light distributions intersected at the center;
a fourth antenna unit 420 comprising four antenna modules 450, 460, 470, 480 with each configured to emit a directional radio beam 421, 422, 423, 424; wherein beam axes 425, 426, 427, 428 of the four directional radio beams 421, 422, 423, 424 are oriented to different directions with any two adjacent directional radio beams having a mutual angle (θ₄) of essentially 90 degrees when projected on the horizontal plane (HP); and the four directional radio beams 421, 422, 423, 424 are arranged along a respective portion P7, P8, P9, P10 of the fourth light distribution 411.

The four directional radio beams 421, 422, 423, 424 are arranged along the respective portion P7, P8, P9, P10 of the fourth light distribution 411 such that the beam axes 425, 426, 427, 428 are covered by or in parallel to the respective portion P7, P8, P9, P10 of the fourth light distribution 411 when projected on the horizontal plane (HP).

Beneficially, the first, second and optionally third horizontally elongated light distribution 211, 311, 411, 511 are aligned with respect to the elongation of a road or street.

1. A streetlighting system comprising a plurality of streetlights for establishing line-of-sight communication links between any two adjacent streetlights out of the plurality of streetlights in the streetlighting system; wherein the streetlighting system comprises:
first streetlight out of the plurality of streetlights comprising:
a first luminaire mounted on a first pole and configured to provide a first horizontally elongated light distribution;
a first antenna unit comprising a first antenna module and a second antenna module wherein the first antenna module is configured to emit a first directional radio beam and the second antenna module is configured to emit a second directional radio beam; wherein beam axes of the first and second directional radio beams are oriented to different directions with a first mutual angle of essentially 180 degrees when projected on a horizontal plane; and the first and the second directional radio beams are arranged along a respective portion of the first horizontally elongated light distribution, such that directional radiation patterns of the first antenna unit are correlated to the first horizontally elongated light distribution of the first streetlight; and
a second streetlight out of the plurality of streetlights comprising:
a second luminaire mounted on a second pole and configured to provide a second horizontally elongated light distribution;
a second antenna unit comprising a third antenna module and a fourth antenna module, wherein the third antenna module is configured to emit a third directional radio beam and the fourth antenna module is configured to emit a fourth directional radio beam; wherein beam axes of the third and the fourth directional radio beams are oriented to different directions with a second mutual angle when projected on the horizontal plane, and wherein 100°≤θ₂≤170° or 190°≤θ₂≤260°; and the third and the fourth directional radio beams are arranged along a respective portion of the second horizontally elongated light distribution, such that directional radiation patterns of the second antenna unit are correlated to the second horizontally elongated light distribution of the second streetlight; and
wherein the first horizontally elongated light distribution is different from the second horizontally elongated light distribution.

2. The streetlighting system of claim 1, wherein the first luminaire comprises a first light source and a first optical element for providing the first horizontally elongated light distribution; and the second luminaire comprises a second light source and a second optical element for providing the second horizontally elongated light distribution, wherein a first combination of the first light source and the first optical element is different from a second combination of the second light source and the second optical element.

3. The streetlighting system according to claim 2, wherein the first light source and the second light source are both light-emitting diode, LED, based light sources, and the first optical element is different from the second optical element.

4. The streetlighting system according to claim 2, wherein the first light source comprises a first matrix of first LEDs and the second LED light source comprises a second matrix of second LEDs, wherein the first matrix is different from the second matrix.

5. The streetlighting system according to claim 2, wherein the first and/or the second optical element comprises one or more peanut lenses.

6. The streetlighting system according to claim 2, wherein the first antenna unit is directly physically mounted to the first optical element to couple directions of the first and the second directional radio beams and the first horizontally elongated light distribution; and the second antenna unit is directly physically mounted to the second optical element to couple directions of the third and the fourth directional radio beams and the second horizontally elongated light distribution, preferably to couple the directions of the radio beams to the respective portions of the first and second horizontally elongated light distributions.

7. The streetlighting system according to claim 1, wherein the second luminaire has a second longitudinal axis, and the third and the fourth directional radio beams are asymmetrically oriented with respect to the second longitudinal axis.

8. The streetlighting system of claim 1, wherein the first antenna unit is configured to assist a first bi-directional communication link between antenna modules mounted on two adjacent streetlights on either side of the first streetlight; and the second antenna unit is configured to assist a second bi-directional communication link between antenna modules mounted on two adjacent streetlights on either side of the second streetlight.

9. The streetlighting system according to claim 1, wherein the second antenna module faces and communicates with the third antenna module.

10. The streetlighting system of claim 1, wherein a directivity of the first, second, third, or fourth antenna module, is further determined by a relative mounting height between the first, second, third, or fourth antenna module and a corresponding antenna module mounted on a corresponding adjacent streetlight for establishing a line-of-sight communication link with the first, second, third, or fourth antenna module, respectively.

11. The streetlighting system according to claim 1, further comprising a third streetlight comprising:
a third luminaire mounted on a third pole and configured to provide a third horizontally elongated light distribution;
a third luminaire mounted on a third pole and configured to provide a third horizontally elongated light distribution;
a third antenna unit comprising a fifth antenna module and a sixth antenna module, wherein the fifth antenna module is configured to emit a fifth directional radio beam and the sixth antenna module is configured to emit a sixth directional radio beam; wherein beam axes of the fifth and the sixth directional radio beams are oriented to different directions with a third mutual angle when projected on the horizontal plane, and wherein 100°≤θ₃≤170° or 190°≤θ₃≤260°; and the fifth and the sixth directional radio beams are arranged along a respective portion of the third horizontally elongated light distribution.

12. The streetlighting system according to claim 11, wherein θ₁≠θ₂≠θ₃.

13. The streetlighting system according to claim 11, wherein the fifth antenna module faces and communicates with the fourth antenna module or the sixth antenna module faces and communicates with the first antenna module.

14. The streetlighting system according to claim 1, wherein the second horizontally elongated light distribution has a curved shape when projected in the horizontal plane and/or the respective portions of the second horizontally elongated light distribution are along the beam axes of the third and fourth directional radio beams.

15. The streetlighting system according to claim 1, wherein the first, second and optionally third horizontally elongated light distribution are aligned with respect to the elongation of a road or street.
